(19) United States
(12) Patent Application Publication
(10) Pub. No.: US 2025/0007032 A1
(43) Pub. Date: Jan. 2, 2025

(54) Battery module and battery

(71) Applicant: Webasto SE, Stockdorf (DE)

(72) Inventors: Hans Beyer, Stockdorf (DE); Volker Böhringer, Stockdorf (DE); Martin Zoske, Stockdorf (DE)

(21) Appl. No.: 18/293,000

(22) PCT Filed: Aug. 1, 2022
(86) PCT No.: PCT/EP2022/071534

§ 371 Date: Jan. 29, 2024

(30) Foreign Application Priority Data
Jul. 30, 2021 (DE) 10 2021 119 944.1

(51) Int. Cl. H01M 10/653; H01M 10/617; H01M 10/625; H01M 10/643; H01M 50/213

(52) U.S. Cl. CPC H01M 10/653; H01M 10/617; H01M 10/625; H01M 10/643; H01M 50/213; H01M 2220/20

(57) ABSTRACT

The present invention relates to a battery module for the construction of a battery, preferably a traction battery for a vehicle, comprising at least two battery cells, preferably cylindrical battery cells, which are held in a cell holder and have temperature-control surfaces which are to be brought into thermally conductive contact with a temperature-control element of a battery housing, wherein an insulation foil arranged on the temperature-control surfaces of the battery cells is provided.

### CROSS-REFERENCE TO RELATED APPLICATIONS

This application is a 35 U.S.C. § 371 National Stage Entry of International Application No. PCT/EP2022/071534 filed Aug. 1, 2022, which claims the priority benefit of German Patent Application Serial Number DE 10 2021 119 944.1 filed Jul. 30, 2021, all of which are incorporated herein by reference in their entireties for all purposes.

### TECHNICAL FIELD OF THE INVENTION

The present invention relates to a battery module for the construction of a battery, for example for the construction of a traction battery for a vehicle, and to such a battery.

### BACKGROUND

Battery systems for vehicles are usually provided with a suitably adapted temperature-control element. This temperature-control element is often configured as a chamber-like base element which enables a medium, for example a liquid medium, to flow through it in a targeted fashion. This base element is usually made from metal.

In order to thermally link each individual battery cell to the temperature-control element, it is known to use a thermally conductive and electrically insulating layer which can additionally compensate geometrical tolerances between the cells and the temperature-control element. This can be a shapable pad (a gap pad) or a viscous paste (a gap filler). Viscous gap fillers can be applied, for example, in serpentine lines on the temperature-control element. When the battery cells are assembled and accordingly pressed against the temperature-control element, air gaps are then closed by the spreading of the gap filler.

Within the sense of the present disclosure, a battery cell is understood to be an electrochemical storage cell, preferably a secondary cell. The term “cell” can be understood in terms of the physical manifestation of the component as the smallest contactable structural unit. In contrast, a battery module is understood to be a structural unit which combines a plurality of battery cells. A battery is correspondingly understood to be a structural unit which is constructed from one or more interconnected battery modules. Such battery systems can moreover comprise a housing accommodating the battery modules, electrical circuits, and a battery management system. Batteries are preferably provided for use in an electric vehicle but can also be used in other vehicles or other fields of application.

Gap fillers can be divided into non-curing and cure-in-place systems. Non-curing systems are highly viscous and usually require a correspondingly high contact pressure of the cells in order to uniformly spread the gap filler and produce the mechanical connection between the cell and the temperature-control element by adhesive force. Curing systems can be adjusted to have a lower viscosity for the application such that just a low contact pressure results in uniform spreading. In addition, a supporting or structural adhesive bonding of the cell to the cooling unit is effected during the curing.

The use of gap pads usually entails high costs and in addition tolerance compensation by gap pads is possible only within narrow limits, for example in relation to the uncompressed thickness relative to the thickness in the case of maximum compression. The achievable adhesive forces between the temperature-control element, gap pad, and battery cells are also limited and unsuitable for a structural connection.

The use of gap fillers is in contrast more cost-effective, enables higher tolerances to be compensated even in the case of complex geometries, and allows the viscosity and adhesive force to be adjusted appropriately to the respective application.

It is not possible to exclude the formation of air pockets when the often two-component gap filler is mixed and applied and when the battery cells are pressed onto the gap filler. In the case of prismatic battery cells which are generally provided ex-works with an electrically insulating foil, and in the case of pouch cells with a cell envelope which is generally floating or has an electrically insulating coating, this generally does not pose any problems in terms of the electrical insulation between the cell and the cooling unit.

However, as cylindrical battery cells are increasingly used in traction batteries for electric vehicles, the following disadvantage can arise when using gap fillers: cylindrical battery cells for automotive applications are generally delivered “blank”, i.e. with no electrically insulating foil on the outside which then, with the exception of the cover, usually bears against the minus potential of the cell. Air bubbles in the gap filler can therefore result in impairment of the abovementioned air gaps and creepage distances and hence of the insulation resistance in (high-voltage) battery systems, which can constitute a safety-critical fault.

### SUMMARY

Starting from the known prior art, an object of the present invention is to provide an improved battery module for the construction of a battery, preferably a traction battery for vehicles, and a battery, preferably a traction battery for a vehicle.

The object is achieved by a battery module for the construction of a battery, preferably a traction battery for a vehicle having the features of claim 1. Advantageous developments can be found in the dependent claims, the description, and the Figures.

Accordingly, a battery module is proposed for the construction of a battery, preferably a traction battery for a vehicle, comprising at least two battery cells which are held in a cell holder and have temperature-control surfaces which are to be brought into thermally conductive contact with a temperature-control element of a battery housing. According to the invention, an electrically insulating insulation foil arranged on the temperature-control surfaces of the battery cells is provided.

The insulation foil is thus arranged such that it is arranged between the battery cells and the temperature-control element and electrical insulation of the battery cells relative to the temperature-control element can thus be achieved.

An electrically insulating insulation foil is understood to be a foil with low electrical conductivity and/or high dielectric strength which is preferably a plastic foil, for example made from PP (polypropylene), PEN (polyethylene naphthalate), PET (polyethylene terephthalate), or PI (polyimide). The foil preferably has a thickness of less than 500 μm, more preferably less than 100 μm. The dielectric strength is preferably at least 10 kV/mm, more preferably at least 30 kV/mm.

A thermally conductive element is preferably arranged on the temperature-control element. In other words, the insulation foil can then be arranged in such a way that, when the battery module is mounted in order to produce a battery, the insulation foil is arranged between the battery cells and the thermally conductive element and electrical insulation between the battery cells and the thermally conductive element is thus supplied.

A thermally conductive element can be, for example, a thermally conductive paste (a gap filler) or a thermally conductive and shapeable pad (a gap pad) which is arranged on the temperature-control element in order to produce a thermal connection between the temperature-control surfaces of the battery cells and the temperature-control element. In other words, the thermally conductive element is provided to connect the battery cells thermally and mechanically (with compensation of any tolerances) to the temperature-control element and thus to keep the thermal resistance of this connection as low as possible.

Cylindrical battery cells, which for example have a non-insulated outer side, are preferably arranged in the battery modules.

The insulation foil is preferably arranged at the temperature-control surfaces of all the battery cells. All the battery cells of the battery module can thus be electrically insulated relative to the temperature-control element with a single insulation foil in an efficient manner.

The insulation foil is preferably arranged over the whole surface of the temperature-control surfaces of the battery cells.

In order to simplify mounting, the insulation foil is preferably adhesively bonded to temperature-control surfaces of battery cells, preferably to temperature-control surfaces of the plurality of battery cells, and particularly preferably to temperature-control surfaces of all the battery cells. Simplified mounting of the battery module can be achieved by the adhesive bonding.

The insulation foil can for this purpose have an adhesive side or a one-sided adhesive coating. It can consequently be made possible for fastening of the foil to the battery cells to be simplified. The insulation foil can, for example, be stuck onto the battery cells in a simple manner. It can furthermore be made possible for the application of the foil to be less time-, material-, and cost-intensive compared with, for example, a single foil on the battery cells.

The insulation foil is more preferably arranged on the temperature-control surfaces of the battery cells and between the battery cells and the thermally conductive element, wherein the thermally conductive element is preferably a gap filler. In other words, a temperature-control element, a thermally conductive element, preferably a gap pad or a gap filler, an insulation foil, and then the battery cells are provided in stacking order in a battery with an above described battery module.

It can consequently be made possible, for example, for a thermally conductive element to be chosen independently of its electrical insulation properties for the production of a battery. It can furthermore be made possible that a layer thickness of the thermally conductive element can be chosen to be so thin that precisely the required tolerance compensation is enabled. It can thus be made possible that a thinner layer of a thermally conductive element reduces the amount of material used and hence the costs and weight and improves the transmission of heat between the temperature-control element and battery cells.

When gap fillers are used, air bubbles or air pockets can, for example, occur which can cause safety-critical insulation faults. Because the battery module comprises an insulation foil, it can be made possible that, for example, safety-critical insulation faults are reduced in the production of a battery or are decreased or excluded with reference to air pockets in the gap filler.

The insulation foil can comprise at least one tab which is arranged so that it is folded out of the plane formed by the temperature-control surfaces. In other words, the tab can be arranged so that it is folded up laterally.

The insulation foil with the tab can thus have an L-shaped form viewed in cross-section. The tab can be folded up at at least one side of the insulation foil. In the case of two or more tabs, the insulation foil can have, for example, a U-shaped form in cross-section. The tabs can be folded up on all four sides, for example, in the case of a rectangular insulation foil.

The tab is preferably formed around the whole periphery and the insulation foil preferably forms a tray-like structure.

Because the insulation foil comprises at least one tab, it can be made possible that the insulation foil simplifies the handling of a battery module during manufacture. For example, it can be made possible by the at least one tab of the insulation foil that fewer contact points on the battery module are accessible to components with a battery potential.

The at least one tab forms, for example, a creepage distance in order to avoid leakage currents. The higher the voltage of the battery, the longer the creepage distance needs to be. It can be made possible by the at least one tab that a creepage distance is lengthened. In other words, it can be made possible that an insulation resistance, for example of the insulation foil of the battery module, is increased. It can furthermore consequently be made possible that the safety of the battery system is increased.

At least one tab can also be arranged between battery cells in order to prevent a thermally conductive element from entering gaps between battery cells.

In other words, the insulation foil can, in addition to its electrically insulating function, also contribute to the thermally conductive element, for example the gap filler, remaining in the region assigned to it and not flowing into other regions of the battery or the battery module.

The above described object is furthermore achieved by a battery having the features of claim 7. Advantageous developments can be found in the dependent claims, the present description, and the Figures.

Accordingly, a battery for a vehicle, preferably a traction battery, is proposed with at least one above described battery module and a housing with a temperature-control element for controlling the temperature of the battery cells accommodated in the at least one battery module, and a thermally conductive element arranged on the temperature-control element. According to the invention, the insulation foil is in contact with the thermally conductive element.

The battery can here comprise a stacking order which includes, in the stacking direction, a temperature-control element, a thermally conductive element, for example a gap filler, an insulation foil, and the battery cells accommodated in the battery module. It can consequently be made possible that, for example, a lower quantity of insulation foil and a lower space requirement are necessary and/or a lower weight is obtained because specifically only the temperature-control surfaces of the battery cells are insulated. It is thus possible, for example, to dispense with the complete enveloping of the battery cells.

The insulation foil can be stuck, for example, onto the battery cells in the stacking order. For this, the insulation foil can comprise, for example, an adhesive side or a one-sided adhesive coating.

In the stacking order, the insulation foil can be connected adhesively, for example, to the gap filler. An adhesive connection can here be produced both via a correspondingly adhesive property of the gap filler and via an adhesive side or an adhesive coating of the insulation foil, or via a combination of the two. In combination with a “cell-side” adhesive coating of the insulation foil, the insulation foil can therefore also have a two-sided adhesive coating.

The insulation foil can extend over a battery module, a structural space unit of a battery, or the whole surface of a battery. The insulation foil can be arranged on the corresponding temperature-control surfaces of the battery cells of a battery structural space unit. The insulation foil can be arranged on the corresponding temperature-control surfaces of the battery cells over the whole surface of a battery. It can consequently be made possible that electrical insulation of a battery module or a battery, respectively, is simplified compared with insulation of each individual battery cell.

It can moreover be made possible that, for example, production-related effort and (production) costs are reduced. It can furthermore be made possible that less insulation foil is required because, for example, specifically the temperature-control surfaces of the battery cells can be insulated.

The object set above is furthermore achieved by an alternative embodiment of a battery, preferably a traction battery for vehicles, having the features of claim 10. Advantageous developments can be found in the dependent claims as well as in the present description and the Figures.

Accordingly, a battery is proposed for a vehicle, preferably a traction battery, comprising at least one battery module with at least two battery cells which are held in a cell holder and have temperature-control surfaces which are to be brought into thermally conductive contact with a temperature-control element of a battery housing, and a thermally conductive element which is arranged between the temperature-control surfaces of the battery cells and the temperature-control element, as well as an insulation foil arranged between the temperature-control element and the thermally conductive element. According to the invention, the insulation foil comprises at least one tab which is arranged so that it is folded out of the plane formed by the temperature-control surfaces.

The insulation foil is preferably arranged on the surface of the temperature-control element. More preferably, the insulation foil is arranged on the temperature-control element and between the temperature-control element and the thermally conductive element, preferably a gap filler. In other words, in the stacking order a temperature-control element, an insulation foil, a thermally conductive element, preferably a gap pad or a gap filler, and the battery cells are provided. The battery can preferably be provided with cylindrical battery cells. The at least one tab can be arranged, for example, so that it is folded up on a supporting structure of the battery housing.

Tabs are understood herein to mean that the insulation foil protrudes above a surface to be insulated and the protrusion is turned up vertically at the sides, for example of the battery module for the embodiment with an insulation foil which is arranged on the battery cells, or for example at the sides of a supporting structure for the embodiment in which the insulation foil is arranged on the temperature-control element. In other words, a tab is understood to be a part of the insulation foil which is turned up along a line or is angled with reference to the (remainder of the) insulation foil. It can consequently be made possible that a creepage distance for a leakage current via the tabs is lengthened. It can, for example, consequently be made possible that a voltage of a battery can be increased or that an insulation resistance is increased and the likelihood of a safety-critical fault reduced.

A gap filler can be applied, for example, on the temperature-control element or on the cell module according to the stacking order of the insulation foil. For example, in the case of a stacking order in which the insulation foil is arranged between battery cells and a thermally conductive element, a gap filler can be applied on the temperature-control element. If the insulation foil is arranged, for example, on the temperature-control element, the gap filler can be applied on the cell module. The gap filler can be applied, for example, in a serpentine form.

### BRIEF DESCRIPTION OF THE FIGURES

Preferred further embodiments of the invention are explained in detail by the following description of the Figures, in which:

FIG. 1 shows schematically a sectional view of a battery with a battery module, a temperature-control element, a thermally conductive element, and an insulation foil; and

FIG. 2 shows schematically a sectional view of a battery with a battery module, a temperature-control element, a thermally conductive element, and an insulation foil in an alternative arrangement and embodiment.

### DETAILED DESCRIPTION

Preferred exemplary embodiments are described below with reference to the Figures. Identical elements, similar elements, or those which have the same effect are here provided with identical reference signs in the different Figures and a repeated description of these elements has been dispensed with in some cases in order to avoid redundancy.

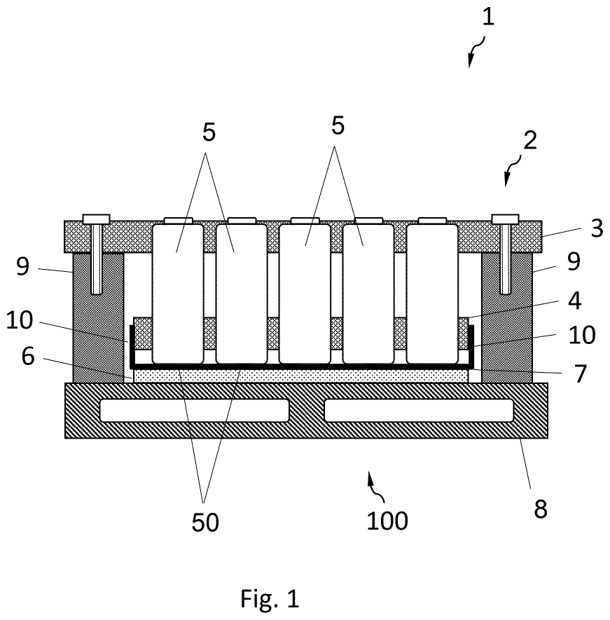

In FIG. 1, a sectional view of a battery 1, for example a traction battery for a vehicle, which can be used for example to supply an electric drive of the vehicle is shown in a highly schematic form.

The sectional view of the battery 1 shows schematically a battery module 2 in which battery cells 5 are accommodated and held, a temperature-control element 8 which is used to control the temperature of the battery cells 5 accommodated in the battery module 2, and a thermally conductive element 6 by means of which a thermal and mechanical connection between the temperature-control element 8 and the battery cells 5 of the battery module 2 is produced.

The battery module 2 comprises here by way of example an upper cell holder 3 and a lower cell holder 4, and the battery cells 5 held in the cell holders 3, 4. As is evident, the battery cells 5 are interconnected in the battery module 2 such that the battery module 2 forms an organizational unit for the battery cells 5.

The battery cells 5 are designed as cylindrical cells in the exemplary embodiment shown. Different battery cells 5 can, however, also be used.

A battery 1 usually comprises a plurality of battery modules 2 in order to supply the appropriate desired voltage and capacity. The battery modules 2 are usually accommodated together with other components in a battery housing 100 (not shown specifically) in order to provide protection from external influences and the ability to control the temperature. The battery housing 100 of the battery 1 usually comprises the temperature-control element 8, wherein the latter can, for example, also form a base of the battery housing 100. A supporting structure 9, which forms a part of the battery housing 100, can furthermore be provided. The battery housing 100 can provide, for example, a space for accommodating the components of the battery 1 which is sealed with respect to environmental influences.

The battery cells 5 have temperature-control surfaces 50 which are arranged on the underside of the battery cells 5 in the Figure. The temperature-control surfaces 50 of the battery cells 5 face the temperature-control element 8 and are intended to be brought into thermally conductive contact with the latter in order to achieve temperature control of the battery cells 5.

In the exemplary embodiment shown, the battery module 2 is connected to the supporting structure 9 of the battery housing 100 via schematically shown fastening means.

The thermally conductive element 6 can be designed, for example, in the form of a thermally conductive paste, for example a gap filler, or a thermally conductive pad, for example a gap pad.

An insulation foil 7 is arranged between the battery cells 5 of the battery module 2 and the thermally conductive element 6. The insulation foil 7 insulates the battery cells 5 with respect to the temperature-control element 8. A flow of current between the battery cells 5 and the temperature-control element 8 can thus be reduced or avoided. This is particularly important when the battery cells 5 are arranged in the battery module 2 without any independent external insulation, as is usually the case in traction batteries which are formed from cylindrical battery cells. In particular when pasty materials are used, insulation can be ensured by the thermally conductive element 6 only with a lot of effort in terms of process engineering. Electrical insulation can be achieved here by means of the insulation foil 7 whatever the specific design of the thermally conductive element 6 and the mounting tolerances of the battery module 2 in the battery 1.

The insulation foil 7 has tabs 10 which are turned up vertically at the sides. The tabs 10 of the insulation foil 7 here bear, for example, against the lower cell holder 4. The tabs 10 can additionally or alternatively bear against the battery cells 5 or be stuck to the latter.

The insulation foil 7 has an adhesive side which here adheres, for example, to the battery cells 5. The insulation foil 7 can be applied with its adhesive side to the thermal contact surfaces of the battery cells 5. The insulation foil 7 can thus correspondingly be supplied as part of the battery module 2 such that the battery module 2 can be handled together with the insulation foil 7. This can simplify, for example, the mounting of the battery module 2 because the battery module 2, together with the insulation foil 7 already assembled thereon, can be inserted into the battery housing 100 with the temperature-control element 8 and the thermal element 6 attached thereto. The insulation foil 7 is then already in the intended position and can come into contact with the thermal element 6 and in this way provide the required insulation.

The thermally conductive element 6 can be a gap filler. The gap filler can be applied to the temperature-control element 8 and the battery module 2 with the insulation foil 7 then placed on top and assembled. The gap filler can, for example, compensate component tolerances and thus form a reliable thermal contact between the battery cells 5 and the temperature-control element 8.

The insulation foil 7 is then arranged between the thermal contact surfaces of the battery cells 5 and the gap filler as a thermally conductive element 6. It can consequently be made possible for a sufficient insulation resistance to be achieved irrespective of the properties of the gap filler used (for example, with respect to electrical conductivity, layer thickness, air pockets) and the technically more complex and cost-intensive insulation of each individual battery cell can be omitted.

The insulation foil 7 can furthermore be connected more simply to the battery module 2 or on the lower cell holder 4 and/or the battery cells 5 by the tabs 10.

If the tabs 10 are formed around the whole periphery, in the case of a thermally conductive element 6 which has particularly good penetration properties, for example a particularly low-viscosity gap filler, it can be avoided that the material of the thermally conductive element 6 flows or passes into regions of the battery module 2 in which it is not intended to be. It can this also be achieved that the volume of the material of the thermally conductive element 6 remains essentially constant between the battery cells 5 and the temperature-control element 8 during mounting and does not flow between the battery cells 5, where it cannot take effect or does not take effect in the intended manner.

In other words, the tabs 10 can be used both to connect the insulation foil 7 to the battery module 2 and to prevent gap filler or another thermally conductive element 6 from entering the gaps between the battery cells 5.

The tabs 10 of the insulation foil 7 can here also be arranged only in regions of the battery module 2 in which gap filler may flow undesirably between the battery cells, i.e. for example at the positions of the gaps. In other words, the tabs 10 can be formed such that they form a shield against the gap filler.

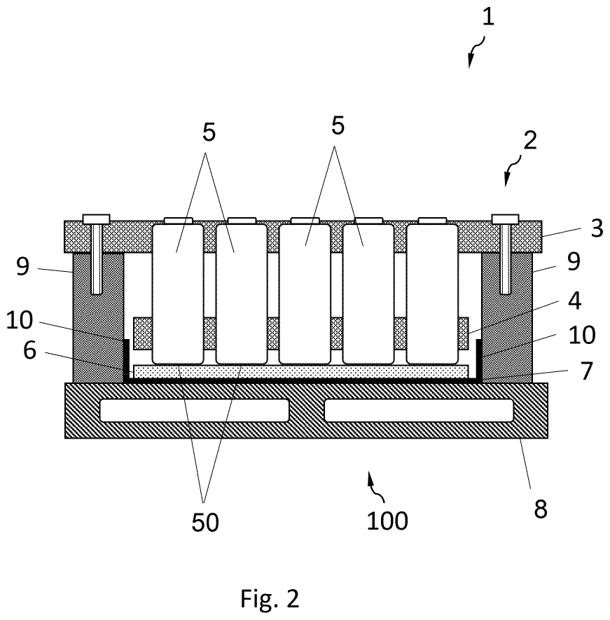

A sectional view of a battery 1, which can be provided for example as a traction battery for a vehicle with an electric motor, is shown schematically in FIG. 2.

The schematic battery 1 is, for example, in turn shown with a battery module 2, a temperature-control element 8, a thermally conductive element 6, and an insulation foil 7.

In the exemplary embodiment shown, the insulation foil 7 is arranged directly on the temperature-control element 8. The thermally conductive element 6 is thus arranged between battery cells 5 and the insulation foil 7 such that the thermally conductive element 6 comes directly into contact with the battery cells 5 of the battery module 2.

The insulation foil 7 can have an adhesive side with which the insulation foil 7 can be stuck on the temperature-control element 8.

The insulation foil 7 has tabs 10 which, as shown by way of example, are folded up at the sides. The insulation foil 7 with the tabs 10 thus lies on the temperature-control element 8 and the supporting structure 9 of the battery housing 100, or is adhesively bonded to these elements.

If the tabs 10 are formed around the whole periphery and the insulation foil 7 thus forms a type of tray, it is possible to avoid that a thermally conductive element 6 with good penetration properties, for example a gap filler, flows out from the region intended for it. When an electrically conductive thermally conductive element 6 is used, it is also possible to avoid electrical contact being made between the battery cells 5 and structures of the battery housing 100.

The battery housing 100 of the battery 1 can be lined, for example, with an insulation foil 7, preferably on a surface which is provided as a temperature-control element 8. The tabs 10 of the insulation foil can be laid against the vertical sides of the battery housing such that an electrically insulated “tray” is created into which, for example, a gap filler or a gap pad can be introduced. A gap filler as a thermally conductive element can be applied, for example, (in serpentine lines) inside the “tray” and then a battery module 2 placed into the battery housing on top of the gap filler. The battery cells 5 touch the gap filler or are at least partially enclosed by the gap filler such that a thermal connection is created with the temperature-control element.

The insulation foil 7 increases a creepage distance such that air pockets in the gap filler cannot cause a critical fault.

Where applicable, all individual features which are illustrated in the exemplary embodiments can be combined with one another and/or exchanged without going beyond the scope of the invention.

### LIST OF REFERENCE SIGNS

1 battery
2 battery module
3 upper cell holder
4 lower cell holder
5 battery cells
6 thermally conductive element (for example, gap filler)
7 insulation foil
8 temperature-control element
10 tab
50 temperature-control surface
100 battery housing

1: A battery module for the construction of a battery, comprising at least two battery cells, which are held in a cell holder and have temperature-control surfaces which are to be brought into thermally conductive contact with a temperature-control element of a battery housing,
wherein an electrically insulating insulation foil arranged on the temperature-control surfaces of the battery cells.

2: The battery module as claimed in claim 1, wherein the insulation foil is arranged on the temperature-control surfaces of all the battery cells.

3: The battery module as claimed in claim 2, wherein the insulation foil is adhesively bonded to temperature-control surfaces of battery cells.

4: The battery module as claimed in claim 3, wherein the insulation foil comprises at least one tab which is arranged so that it is folded out of the plane formed by the temperature-control surfaces.

5: The battery module as claimed in claim 4, wherein the tab is formed around the whole periphery.

6: The battery module as claimed in claim 4, wherein at least one tab is arranged between battery cells in order to prevent a thermally conductive element from entering gaps between battery cells.

7: A battery for a vehicle, with at least one battery module as claimed in one of the preceding claims and a housing with a temperature-control element for controlling the temperature of the battery cells accommodated in the at least one battery module, and a thermally conductive element arranged on the temperature-control element, characterized in that the insulation foil is in contact with the thermally conductive element.

8: The battery as claimed in claim 7, wherein, starting from the temperature-control element, first the thermally conductive element and then the insulation foil and then the battery cells are stacked one on top of the other.

9: The battery as claimed in claim 8, wherein the thermally conductive element is formed as a thermally conductive paste, for example a gap filler, and/or of a thermally conductive pad, for example a gap pad.

10: A battery for a vehicle, comprising at least one battery module with at least two battery cells which are held in a cell holder and have temperature-control surfaces which are to be brought into thermally conductive contact with a temperature-control element of a battery housing, and a thermally conductive element which is arranged between the temperature-control surfaces of the battery cells and the temperature-control element, as well as an insulation foil arranged between the temperature-control element and the thermally conductive element,
wherein the insulation foil comprises at least one tab which is arranged so that it is folded out of the plane formed by the temperature-control surfaces.

11: The battery as claimed in claim 10, wherein the tab is formed around the whole periphery.

12: The battery module as claimed in claim 1, wherein the at least two battery cells are cylindrical battery cells.

13: The battery module as claimed in claim 3, wherein the insulation foil is adhesively bonded to temperature-control surfaces of the plurality of battery cells.

14: The battery module as claimed in claim 5, wherein the insulation foil forms a tray-like structure.

15: The battery for a vehicle as claimed in claim 10, wherein the at least two battery cells are cylindrical battery cells.

16: The battery as claimed in claim 11, wherein the insulation foil forms a tray-like structure.
